(19) United States
(12) Patent Application Publication
(10) Pub. No.: US 2024/0387891 A1
(43) Pub. Date: Nov. 21, 2024

(54) BATTERY COLOR CHANGE MATERIAL TO VISUALLY INDICATE BATTERY MALFUNCTION

(71) Applicant: LENOVO (SINGAPORE) PTE. LTD., SINGAPORE (SG)

(72) Inventors: Arnold Weksler, Morrisville, NC (US); Bouziane Yebka, Morrisville, NC (US); John C. Mese, Morrisville, NC (US); Nathan Peterson, Morrisville, NC (US); Russell S. VanBlon, Morrisville, NC (US); Mark Delaney, Morrisville, NC (US)

(21) Appl. No.: 18/320,892

(22) Filed: May 19, 2023

(51) Int. Cl. H01M 10/48; H01M 50/124

(52) U.S. Cl. CPC H01M 10/488; H01M 50/1243

(57) ABSTRACT

In one aspect, an apparatus includes a battery. The battery includes at least one battery cell, a casing that houses the at least one battery cell, and material coupled to an exterior of the casing. The material is configured to change color based on interaction with matter from the at least one battery cell based on the matter being released from inside the casing.

### FIELD

The disclosure below relates to technically inventive, non-routine solutions that produce concrete technical improvements. In particular, the disclosure below relates to batteries with material on their exterior to visually indicate a battery malfunction.

### BACKGROUND

As recognized herein, batteries might begin to leak toxic matter but still have enough voltage to continue powering the device in whey they are disposed. In the meantime, the user might not know about the leak, which is particularly true for devices that do not monitor their own battery health, such as flashlights, remote controls, radios, and many other “dummy” household devices. In such situations, the user might not discover the leak until after the device stops working and only then discover that the leak has permanently damaged the device itself (e.g., damaged the device's electrical contacts so that the device can no longer be powered by healthy replacement batteries). Not only that, but when attempting to remove the leaking battery, the user might be exposed to harmful agents that have leaked from the battery, compromising the user's health. There are currently no adequate solutions to the foregoing technological problems.

### SUMMARY

Accordingly, in one aspect, an apparatus includes a battery. The battery includes at least one battery cell, a casing housing the at least one battery cell, and a material coupled to an exterior of the casing. The material is configured to change color based on interaction with matter from the at least one battery cell based on the matter leaking from inside the casing.

In various example implementations, the material may be paper-based. Also in various example implementations, the material may be impregnated with a litmus, delphinidin, a cyanidin, and/or an anthocyanin. Still further, if desired an exterior surface of the material facing away from the casing may be laminated with nylon and/or nitrile, with the nylon/nitrile dissolving based on contact with battery acid or other matter from inside the battery cell.

Also in various example implementations, based on interaction with matter from the at least one battery cell, the material may change to a red color from a non-red color. The non-red color may be a blue color, for example.

Also note that in some examples, the material itself may be non-toxic.

In another aspect, an apparatus includes a casing for at least one battery cell and material coupled to the casing. The material is configured to change color based on contact with matter from the at least one battery cell based on the matter being released external to the casing from inside the casing.

In various examples, the material may be paper-based. If desired, the material may also include litmus, delphinidin, cyanidin, and/or anthocyanin. Additionally, in some examples a surface of the material facing away from the casing may be laminated with nylon and/or nitrile.

Still further, in some instances the material may change to a color from the red analogous color group based on interaction with matter from the at least one battery cell.

In still another aspect, a method includes providing at least one battery cell, providing a casing housing the at least one battery cell, and providing material coupled to an exterior of the casing. The material is configured to change color based on interaction with matter from the at least one battery cell based on the matter being released from inside the casing.

The details of present principles, both as to their structure and operation, can best be understood in reference to the accompanying drawings, in which like reference numerals refer to like parts and in which:

### BRIEF DESCRIPTION OF THE DRAWINGS

FIG. 1 is a block diagram of an example system that houses a battery and is powered by the battery consistent with present principles;

FIG. 2 shows a perspective view of example battery casing, color-change material, and encasing laminate layers consistent with present principles;

FIG. 3 shows a top-plan view of the example color-change material and laminate layers consistent with present principles;

FIGS. 4A-C show an example color change material being dipped in various substances in a receptacle to further illustrate present principles;

FIG. 5 is an example graphic demonstrating litmus chemistry consistent with present principles;

FIG. 6 is an example chart showing different color-change reactions for different litmus types that may be used consistent with present principles; and

FIG. 7 shows a perspective view of an example cylindrical battery wrapped with an example color-change material consistent with present principles.

### DETAILED DESCRIPTION

Among other things, the detailed description below deals with making a user aware of battery leakage, including for devices that do not monitor battery health themselves. For example, present principles may be used for batteries in flashlights, television remote controls and other types of remote controls, AM/FM/XM radios, etc. However, present principles may also be used for batteries in smart devices that monitor battery health at the battery management unit (BMU) level, CPU level, etc. as well.

In any case, apparatuses and methods are disclosed to help a user recognize a battery leak so the user may replace the battery sooner. This, in turn, helps to avoid electrical shorts and additional (and sometimes permanent) damage to the device, like damage to the device's electrical contacts themselves, while also improving user safety in handling a malfunctioning battery. Thus, although sometimes batteries might begin leaking and still have sufficient voltage to continue powering the device itself, using principles set forth below, the user may be made aware of the malfunction sooner to prompt the user to take action and therefore prevent this leaking from worsening while the device itself might still otherwise be powered. Principles set forth below may therefore improve on existing “dumb” batteries/household devices that do not have the capability to do active battery monitoring themselves (and still also provide improvements to devices that may in fact do so).

Accordingly, in one example implementation, a battery may be wrapped with a very thin layer of material at the positive and negative terminals of the battery as well as at other portions of the battery's casing. As the leak begins, the battery leak will cause a chemical reaction with the material that will change the color of the material to a color that might catch the user's eye when the user looks at it (e.g., red).

In some examples, only part of the paper-based material may be impregnated with a litmus or other color-changing agent, and the color-changing agent may be impregnated into the paper-base to spell a warning to the user like “replace” or “caution” while surrounding portions of the paper base maintain their original/unchanged color. So, for example, the material may be impregnated in shapes or a tracing spelling the word “replace” so that “replace” is shown in red when those impregnated portions of the material contact battery acid, while other portions of the material continue to be white or blue notwithstanding contact with the battery acid themselves. This may further aid the user in knowing to take action.

Thus, present principles may be used for batteries with lead acid battery chemistry, including lead acid batteries built with several individual cells containing layers of lead alloy plates immersed in an electrolyte solution and made of 35% Sulfuric acid (H2SO4) and 65% water (as an example). Therefore, the material that is used may be configured to chemically react with one or more components of the electrolyte, such as the water or the sulfuric acid itself.

Prior to delving further into the details of the instant techniques, note with respect to any computer systems discussed herein that a system may include server and client components connected over a network such that data may be exchanged between the client and server components. The client components may include one or more computing devices, including televisions (e.g., smart TVs, Internet-enabled TVs), computers such as desktops, laptops, and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, control lines, registers, and shift registers. Moreover, any logical blocks, modules, and circuits described herein can be implemented or performed with a system processor, a digital signal processor (DSP), a field programmable gate array (FPGA), or other programmable logic devices such as an application-specific integrated circuit (ASIC), discrete gate or transistor logic, discrete hardware components, or any combination thereof designed to perform the functions described herein. A processor can also be implemented by a controller or state machine, or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as a system 100 described below, such an application may also be downloaded from a server to a device over a network such as the Internet.

Software modules and/or applications described through flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic, when implemented in software, can be written in an appropriate language such as but not limited to a hypertext markup language (HTML)-5, Java®/JavaScript, C #or C++, and can be stored on or transmitted from a computer-readable storage medium such as a hard disk drive (HDD) or solid-state drive (SSD), a random access memory (RAM), read-only memory (ROM), electrically erasable programmable read-only memory (EEPROM), a hard disk drive or solid-state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer-readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

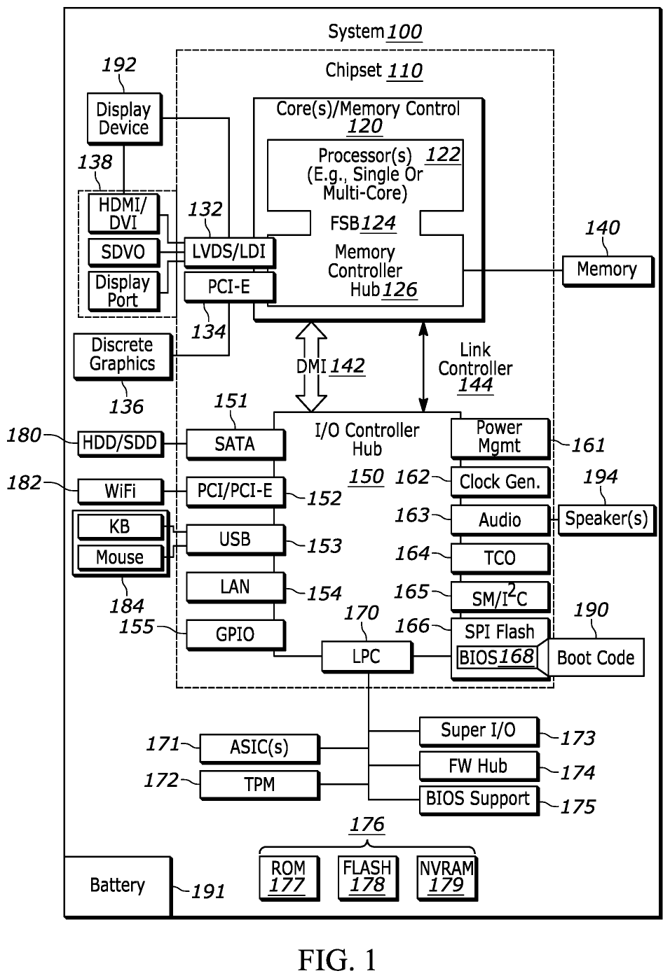

Now specifically in reference to FIG. 1, an example block diagram of an information handling system and/or computer system 100 is shown that is understood to have a housing for the components described below. Note that in some embodiments, the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized devices.

As shown in FIG. 1, system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on the brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under the direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independently of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing, or reading and writing information on one or more drives 180 such as HDDs, SDDs, or a combination thereof, but in any case the drives 180 are understood to be, e.g., tangible computer-readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice, and various other devices (e.g., cameras, phones, storage, media players, etc.).

In the example of FIG. 1, the LPC interface 170 provides for the use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include a battery 191, such as a single-cell battery or battery pack with multiple cells. In addition to containing one or more battery cells, the battery 191 may include its own one or more processors, such as a microprocessor or any other type of processor that might be provided as part of a gas gauge or battery management unit (BMU) for the battery 191. Non-transitory storage may also be included in the battery 191, with the storage storing firmware used to monitor the battery 191 and perform other functions. Random access memory (RAM) and other components may also be included in the battery 191, such as one or more sensors for sensing/measuring things related to the battery 191 and/or battery cells within, such as temperature, voltage, electric potential, age, impedance, state of charge, etc. Thus, these sensors may provide input/measurements to the processor(s) within the battery 191 and/or the processor(s) 122.

Additionally, note that one or more battery cells within the battery 191 may be configured in jellyroll format. The cells may also be configured in pouch cell format in which the strip(s) of active materials are folded or in a stacked format if desired. Regardless, the battery cells may be Lithium-ion battery cells, alkaline-based battery cells, acid-based battery cells, and/or other types of battery cells consistent with present principles.

It is to be further understood, consistent with present principles, that the battery 191 may be electrically coupled to and power the system 100, and/or individual components thereof, using battery power. The system 100, and/or battery 191 in particular, may also be electrically coupled to at least one charge receiver on the system 100 for receiving a charge via an AC/DC power supply connected to an AC power source (e.g., a wall outlet providing AC power) to charge the one or more battery cells in the battery 191. Thus, the charge receiver may include at least one circuit configured for receiving power from a wall outlet (or other AC power source) via the power supply and then providing power to the system 100 to power it and also providing power to the battery 191 to charge the cells within the battery 191. In some examples, wireless charging using a wireless charge receiver and wireless charge transmitting pad may be used.

Notwithstanding the foregoing, it is to be understood that a battery consistent with present principles need not necessarily be a smart battery as set forth above and may instead be established by one or more battery cells while not including a processor, storage, and even a charging circuit as mentioned above.

In any case, though not shown for simplicity, it is to be understood that in some embodiments the system 100 may further include a gyroscope that senses and/or measures the orientation of the system 100 and provides related input to the processor 122, an accelerometer that senses acceleration and/or movement of the system 100 and provides related input to the processor 122, and/or a magnetometer that senses and/or measures the directional movement of the system 100 and provides related input to the processor 122.

Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Also, the system 100 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood, at least based on the foregoing, that the system 100 is configured to undertake present principles.

Moving on from FIG. 1, note consistent with present principles that each battery cell of a battery consistent with present principles may include an anode, a cathode, and an electrolyte between the anode and the cathode.

The battery may also include a casing housing the battery cell(s) as well as material coupled to an exterior of the casing. For example, the material may be disposed on, wrapped around, integrated with, or otherwise in physical contact with the battery casing (and be exposed to external elements). The material may be configured to change color based on interaction with matter from the at least one battery cell based on the matter leaking from inside the casing. The material may thus establish a color-change layer wrapped around at least part of the battery, and the color change layer may be paper-based and impregnated with a litmus in various non-limiting examples. Nylon and/or nitrile may then establish a laminated film over top of the color change layer to provide for moisture protection, with the film still melting/dissolving upon contact with acid or other internal matter from the battery. Also in various non-limiting examples, the color change layer itself may change to red when exposed to the acid and/or other internal matter once that matter dissolves the film layer.

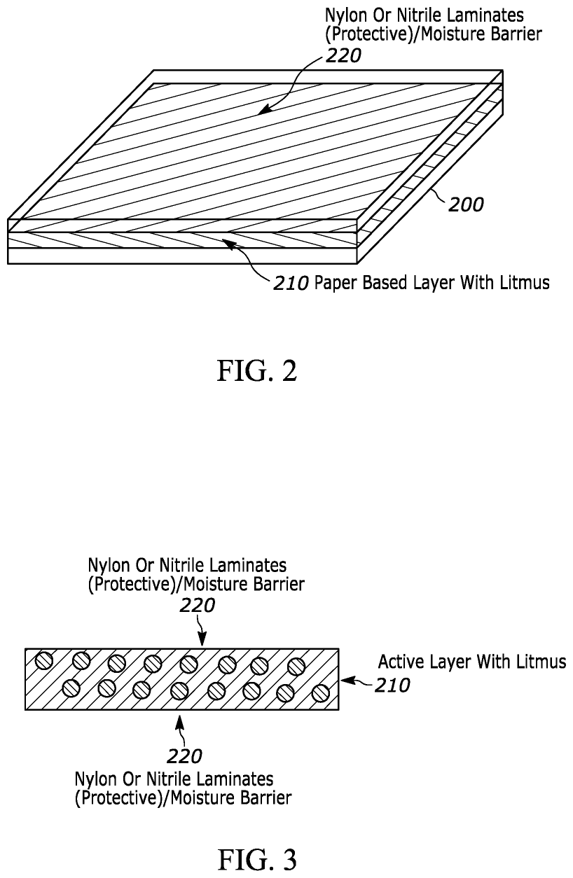

These layers are demonstrated in FIG. 2. As shown in this perspective view, a battery casing may establish a first layer 200, with the casing housing an anode, cathode, and electrolyte of a battery cell as mentioned above. A paper-based layer 210 with a litmus is then overlaid on top of the casing 200. A nylon and/or nitrile laminate layer 220 is then layered on top of the layer 210, sandwiching the layer 210 between the casing 200 and laminate layer 220. The layers 200-220 may be glued together or bonded using another non-toxic substance, for example. In any case, the layer 210 may thus be disposed external to the casing but still encapsulated by the laminate layer 220, with the laminate layer 220 providing a protective moisture barrier. For example, the layer 220 may be protective against water/H2O in that it may not dissolve based on contact with H2O (but may still dissolve when coming into contact with internal battery electrolyte that has been expelled, such as acidic electrolyte, thus exposing the layer 210 itself to then change color).

FIG. 3 further illustrates. As shown in this top plan view, the laminate layer 220 may be transparent or at least semitransparent so that the active litmus layer 210 can be appreciable with the naked eye from external to the battery/layer 220. In some examples, the layer 210 may be perforated as shown. Additionally or alternatively, in certain examples the layer 210 may have the color change agent on only a portion, e.g., to spell “caution” and/or present a “caution” symbol with the color-change agent as set forth above.

As also shown in FIG. 3, the layer 210 need not extend over all surfaces of the battery casing and may instead establish a strip that might wrap around or circumscribe part of the battery casing. But further note that to ensure adequate moisture protection, the layer 220 may still not only cover the layer 210 itself but also extend out from all edges of the layer 210 to cover greater area than the layer 210 itself and help prevent external moisture from reaching the layer 210 not just from over top of the layer 210 but also from the sides.

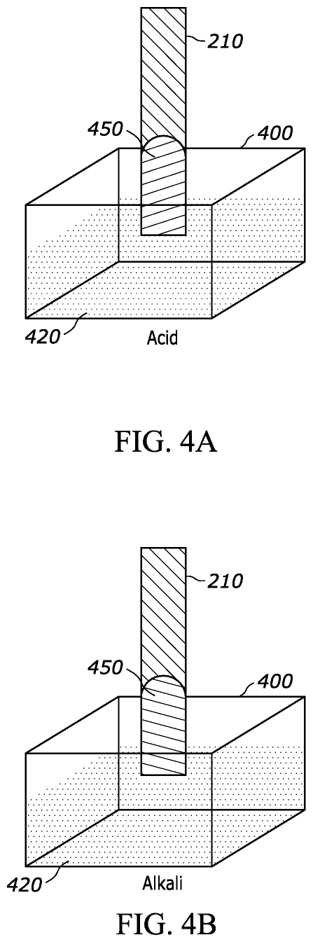

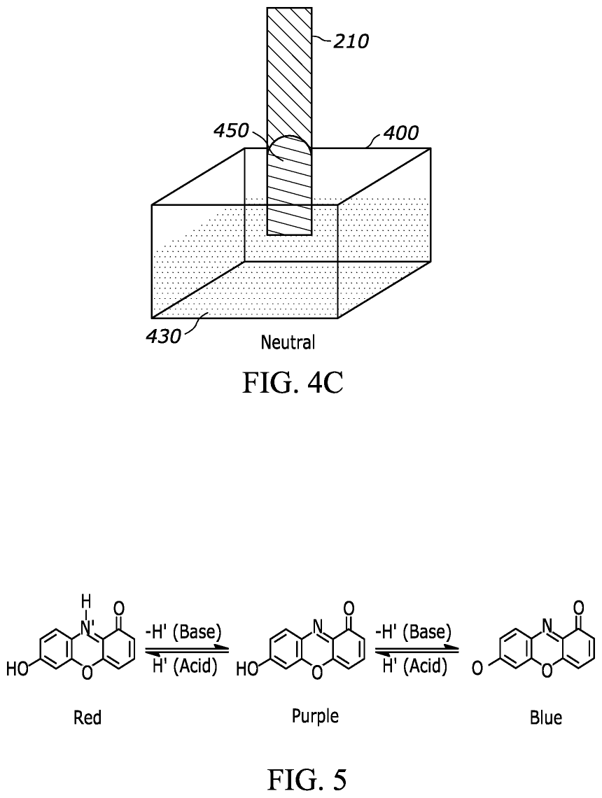

Turning now to FIGS. 4A-C, present principles are further illustrated by showing the layer 210 being dipped in various substances in a receptacle 400. Owing to the paper-based layer 210 being impregnated with a litmus, when dipped in acid 410 a portion 450 of the layer 210 may absorb the acid 410 and turn red or another shade from the red analogous color group. However, when the layer 210 is dipped in an alkali per FIG. 4B or a neutral solution such as water/H2O per FIG. 4C, the portion 450 might still absorb the alkali/neutral solution but may not change color other than turning its existing color darker owing to becoming wet. Thus, this particular paper-based layer 210 with litmus may be particularly useful for covering the casing of a lead acid battery so that the layer 210 can change color based on contact with acid from the acid battery's electrolyte when the electrolyte leaks from the casing during a battery malfunction.

FIG. 5 shows a particular example litmus chemistry consistent with present principles, with it being further noted that different chemistries may be used for the impregnated layer to change to a particular, desired color depending on implementation. In any case, here the litmus itself may be based on the 7-hydroxyphenoxazone core. In the presence of an acid, the imine nitrogen is protonated (left side of the graphical equation). While in a base (e.g., alkali), the phenolic oxygen is deprotonated (right side of the graphical equation). Thus, the “acid” form, protonated on the imine nitrogen, is red, and the basic form is the phenolate and is blue. In between (middle of the graphical equation) and in the pH range of 4.5-8.3, the litmus may be neither protonated nor deprotonated and the neutral form may be purple.

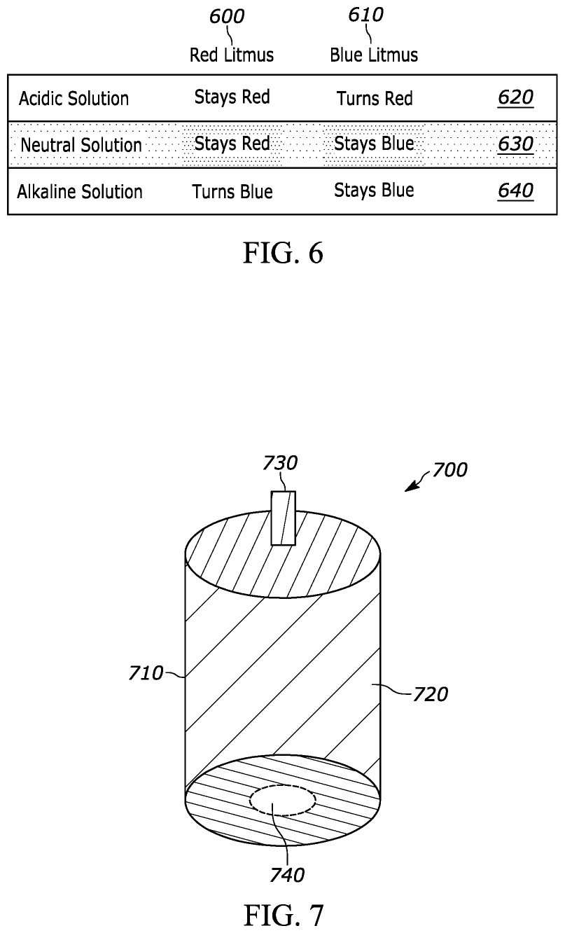

FIG. 6 further illustrates present principles. Two columns 600, 610 are shown along with three rows 620, 630, and 640. Column 600 relates to use of red litmus consistent with present principles, while column 610 relates to use of blue litmus consistent with present principles. This figure therefore indicates different litmus that might be used depending on a particular battery's electrolyte chemistry (and/or anode/cathode chemistry), illustrating the color change that the respective litmus would undergo when impregnated into a paper-based material and in physical contact with leaked electrolyte or other internal battery matter.

Accordingly, per row 620, red litmus may stay red when contacting an acidic solution, while blue litmus may turn red from blue when contacting an acidic solution. Thus, blue litmus may be used for acidic-based electrolyte in acid-based batteries.

Per row 640, red litmus may turn from red to blue when contacting an alkaline solution, while blue litmus may stay blue when contacting an alkaline solution. Thus, red litmus may be used for alkaline-based electrolyte in alkaline-based batteries.

By contrast, row 630 illustrates that red litmus may stay red when contacting a neural solution such as water, and that blue litmus may stay blue when contacting a neutral solution such as water.

Accordingly, depending on battery chemistry, red or blue litmus may be used as described above so that the litmus may visually indicate an electrolyte leak based on the litmus' color change, while the litmus regardless of if red or blue still does not change color when coming into contact with a neutral solution that might be accidentally introduced from external to the battery (instead of matter that has leaked from within the battery), further improving the notification system.

With the foregoing in mind, a specific example embodiment will now be described in reference to FIG. 7. Specifically, this figure shows a battery 700 with a cylindrical casing 710 and a color-change material 720 as described above wrapped around the casing 710. The battery 700 may therefore be an AA battery, AAA battery, C battery, D battery, etc. However, further note that a battery with color-change material consistent with present principles may take another shape as well. For example, the battery might also be a pouch battery, a rectangular prism-shaped battery such as a 9-volt battery or lead acid vehicle battery, a coin battery such as a watch battery, a hybrid vehicle battery or electric vehicle battery, etc.

In any case, as shown in the perspective view of FIG. 7, the battery 700 may have a positive terminal 730 and negative terminal 740 (the negative terminal 740 being in partial transparent view). The terminals 730, 740 may be coupled to or form part of the casing 710 that encapsulates one or more battery cells of the battery 700. Shading at the terminals 730, 740, surrounding horizontal surfaces, and sidewalls of the casing 710 represent the color-change material 720 as described above. The material 720 may therefore cover some or all of the otherwise exposed exterior surfaces of the battery 700. The material 720 may be wrapped or glued on, but may additionally or alternatively be pressed into, engrained with, integrated with, or otherwise be coupled to the external surfaces of the casing 710.

Thus, should electrolyte or other matter leak out of the casing 710, the material 720 may chemically react to the matter when in physical contact therewith. This in turn may notify the user of a battery malfunction when the user looks at the battery, prompting the user to remove and discard the malfunctioning battery from the device in which the malfunctioning battery is disposed and to insert a new battery into the device before the malfunctioning battery causes further damage to the device (and/or poses a greater health hazard to the user in handling the malfunctioning battery as more internal matter leaks out or is otherwise released external to the battery).

Note here that the device in which the battery 700 is disposed and engaged with device electrical contacts to power the device might be, for example, a flashlight, a television remote control or other type of remote control such as a garage door opener or vehicle key fob, an AM/FM/XM radio, a home cooking appliance, an Internet of things (IoT) device, a lantern, etc.

Moving on from FIG. 7, again note that delphinidin, cyanidin, and anthocyanins can be used since they can change color based on the pH of a substance that is introduced to them. Also note that a structural transformation of cyanidin-3-O-glycoside may be used consistent with present principles. The color can be controlled by a subtract matrix.

Also note consistent with present principles that the structure of the color-change material need not necessarily be paper-based. For example, the material might also be non-toxic polymer-based, hemp-based, cotton-based, etc. Also note that in addition to or in lieu of inserting litmus into the base structure, delphinidin, a cyanidin, another anthocyanin type, and/or another non-toxic pigment may also be used that also changes color when exposed to released battery matter. However, in specific example implementations, the surface of the material facing away from the battery casing may still be laminated with nylon and/or nitrile for moisture protection as discussed above.

In any case, note that example pigments and other color-change chemicals that may be used consistent with present principles may change color from one color in one analogous color group to another color in a different analogous color group. Thus, based on interaction with matter released from a battery cell, the material with impregnated color-change chemical may (for example) change from a color in the blue, blue-violet, or blue-green analogous color group to a color in the yellow, orange, red-orange or red analogous color group (and vice versa, depending on implementation).

Also note that in some examples, only part of the paper-based material or other base material consistent with present principles may be impregnated with a litmus or other color-changing agent, and the color-changing agent may be impregnated into the paper-base to spell a warning to the user like “replace” or “caution” while surrounding portions of the paper base maintain their original/unchanged color when contacting internal battery matter. So, for example, part of the base material as located on a sidewall of the battery may be impregnated in shapes or tracings spelling the word “replace” so that “replace” is shown in red when those impregnated portions of the material contact battery acid, while other portions of the material continue to be white or blue notwithstanding contact with the battery acid themselves. Additionally or alternatively, a triangular “caution” symbol with an exclamation mark in the middle, a circle with an “X” inside, and/or another type of graphic may also be configured for color change upon interaction with acid or other matter from inside the battery while surrounding portions of the base material are not (even when physically interacting by the matter). These things may further aid the user in knowing to take action as described herein (e.g., handle the malfunctioning battery with caution while replacing it).

Also note that present principles may involve methods for providing battery cells, providing casings housing the cells, and providing color-change materials coupled to the exteriors of the casings consistent with present principles. The components may be provided individually, in certain sub-combinations, and/or as a fully-assembled battery. These methods may therefore include vending such batteries, manufacturing such batteries, shipping such batteries to a third party, etc.

It is to be understood that while present principals have been described with reference to some example embodiments, these are not intended to be limiting and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

What is claimed is:

1. An apparatus, comprising:
a battery, the battery comprising:
at least one battery cell;
a casing housing the at least one battery cell; and
material coupled to an exterior of the casing, the material configured to change color based on interaction with matter from the at least one battery cell based on the matter leaking from inside the casing.

2. The apparatus of claim 1, wherein the material is paper-based.

3. The apparatus of claim 2, wherein the material is impregnated with a litmus.

4. The apparatus of claim 2, wherein the material is impregnated with delphinidin.

5. The apparatus of claim 2, wherein the material is impregnated with a cyanidin.

6. The apparatus of claim 2, wherein the material is impregnated with an anthocyanin.

7. The apparatus of claim 2, wherein a surface of the material facing away from the casing is laminated with nylon that dissolves based on contact with battery acid or other matter from inside the battery cell.

8. The apparatus of claim 2, wherein a surface of the material facing away from the casing is laminated with nitrile that dissolves based on contact with battery acid or other matter from inside the battery cell.

9. The apparatus of claim 1, wherein based on interaction with matter from the at least one battery cell, the material changes to a red color from a non-red color.

10. The apparatus of claim 6, wherein the non-red color is a blue color.

11. The apparatus of claim 1, wherein the material is non-toxic.

12. An apparatus, comprising:
a casing for at least one battery cell; and
material coupled to the casing, the material configured to change color based on contact with matter from the at least one battery cell based on the matter being released external to the casing from inside the casing.

13. The apparatus of claim 12, wherein the material is paper-based.

14. The apparatus of claim 12, wherein the material comprises a litmus.

15. The apparatus of claim 12, wherein the material comprises delphinidin.

16. The apparatus of claim 12, wherein the material comprises a cyanidin.

17. The apparatus of claim 12, wherein the material comprises an anthocyanin.

18. The apparatus of claim 12, wherein a surface of the material facing away from the casing is laminated with nylon and/or nitrile.

19. The apparatus of claim 12, wherein based on interaction with matter from the at least one battery cell the material changes to a color from the red analogous color group.

20. A method, comprising:
providing at least one battery cell;
providing a casing housing the at least one battery cell; and
providing material coupled to an exterior of the casing, the material configured to change color based on interaction with matter from the at least one battery cell based on the matter being released from inside the casing.
